(19) United States
(12) Patent Application Publication
(10) Pub. No.: US 2015/0155688 A1
(43) Pub. Date: Jun. 4, 2015

(54) Energy Saving Annular Gasket

(71) Applicant: Yi Xiang Cui, Brooklyn, NY (US)

(72) Inventor: Yi Xiang Cui, Brooklyn, NY (US)

(21) Appl. No.: 14/093,272

(22) Filed: Nov. 29, 2013

(51) Int. Cl. H01T 13/08

(52) U.S. Cl. CPC H01T 13/08

(57) ABSTRACT

An annular gasket with inner rabbet edge and a corresponding opposite flat edge to be installed flush between a hex-base of a spark plug and bottom base of a cylinder head, which aides in the expulsion of exhaust air away from the spark plug's ground electrode resulting in a saving of fuel and energy, increase in horsepower, cleaner emissions, and increased life of an engine system.

### CROSS-REFERENCE TO RELATED APPLICATIONS

None.

### BACKGROUND OF THE INVENTION

There have been designs of devices used on vehicles to increase fuel economy, but none of those is similar to the one disclosed in this patent application, to wit, a annular gasket installed from a threaded, ground electrode end up and against a hex-base of a spark plug body which saves fuel and energy, increases horsepower, results in cleaner emissions, and increases the life of an engine system.

### SUMMARY OF THE INVENTION

The invention contemplates the provision of an annular gasket with inner rabbet edge and a corresponding opposite flat edge which, when properly installed that will allow for a more effective clearance of exhaust air in a piston cylinder, that will allow for more fresh air to be drawn into the piston cylinder such that there is also cleaner mixture of air and gasoline. More specifically, the annular gasket with inner rabbet edge and corresponding opposite flat edge causes for the evacuation of exhaust air away from the ground electrode of the spark plug which allows for a clearer mixture of air and fuel around and near the ground electrode.

The annular gasket with inner rabbet edge and corresponding opposite flat edge is installed in place of the washer between the hex-base of a spark plug and the bottom base of the cylinder head. The annular gasket with inner rabbet edge may be installed with the rabbet edge facing up and flat against the hex-base of the spark plug or down and flat against the bottom base of the cylinder head. The annular gasket with inner rabbet edge will he sized accordingly to the size of the spark plug and will generally about the same size of the washer corresponding with the spark plug.

When a spark plug is screwed into a cylinder head of an internal combustion engine, there is a small gap between the hex-base of a spark plug body and the bottom base of the cylinder head into which the threaded body, lower shell and electrode of the spark plug are inserted, and thereafter protrude into the combustion chamber. During the compression cycle, air within the piston is lost through this gap. At the power stage, the high pressure of air being released will cause the exhaust air to be dispelled from the piston chamber. This will allow for the introduction of fresher air surrounding the ground electrode at the next intake stage.

Air that is held within the inner rabbet edge of the annular gasket will be under a tremendous amount of pressure during the compression stage. The air held within and the rabbet edge will release at a great rate during the exhaust stage resulting in the removal of any additional exhaust away from the ground electrode.

The effect of the washer will cause for the expulsion of a greater amount of exhaust air while allowing for a greater intake of fresh air, which in return, will result in a saving of fuel, increase of horsepower. cleaner emissions, and an increase in the life of the engine system.

### DRAWINGS

(A) Figures

FIG. 1 is a two-dimensional top plan view of an annular gasket with inner rabbet edge.

FIG. 2 is a two-dimensional side plan view of an annular gasket with inner rabbet edge.

FIG. 3 is a two-dimensional side view plan of an annular gasket with inner rabbet edge partially installed onto the spark plug.

FIG. 4 is a three-dimensional view of one half of a spark-plug including the spark plug body beginning from the bottom of the hex-nut (not pictured); thread, tip, and ground electrode.

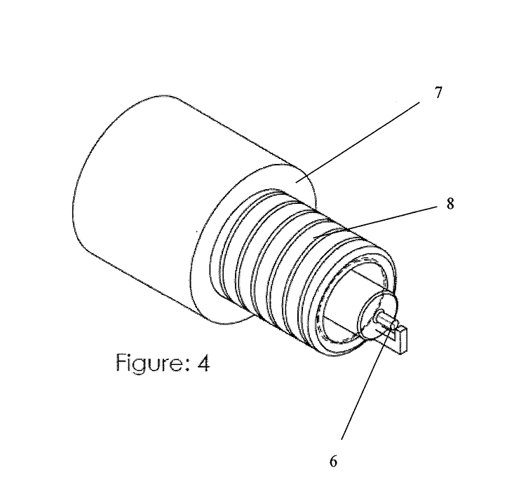

FIG. 5 is a three-dimensional top plan view of an annular gasket with inner rabbet edge.

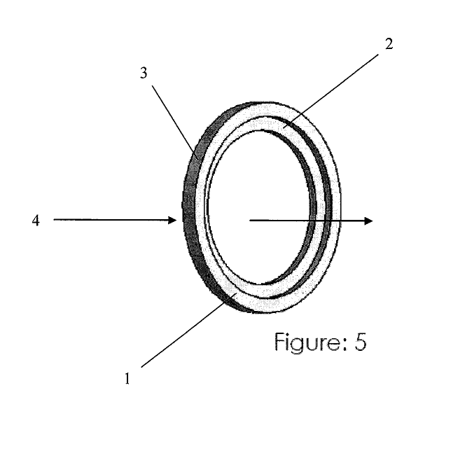

FIG. 6 is a three-dimensional view plan of an annular gasket with inner rabbet edge partially installed onto the spark plug thread.

(B) Reference Numerals

1 top outer edge

2 rabbet inner edge

3 outer edge of annular gasket\

4 hole

5 flat bottom edge\

6 ground electrode

7 hex-base of spark plug

8 threads

### DETAILED DESCRIPTION OF THE INVENTION

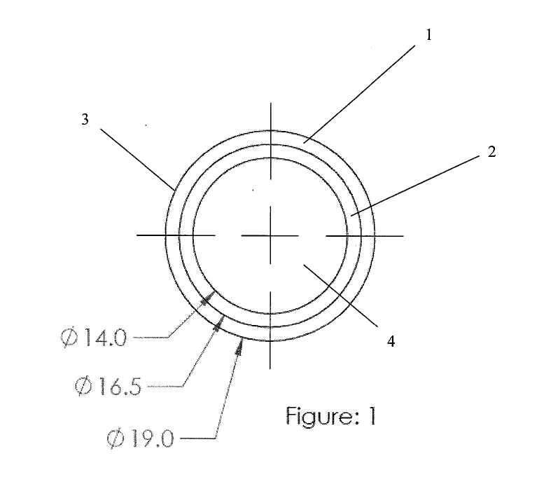

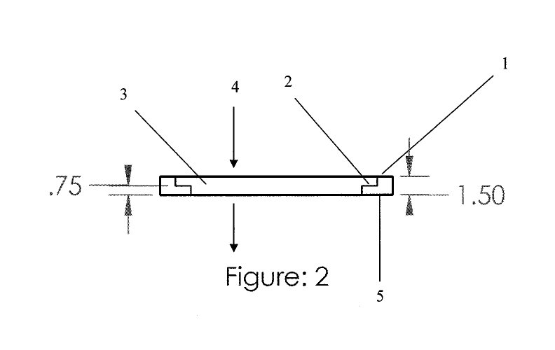

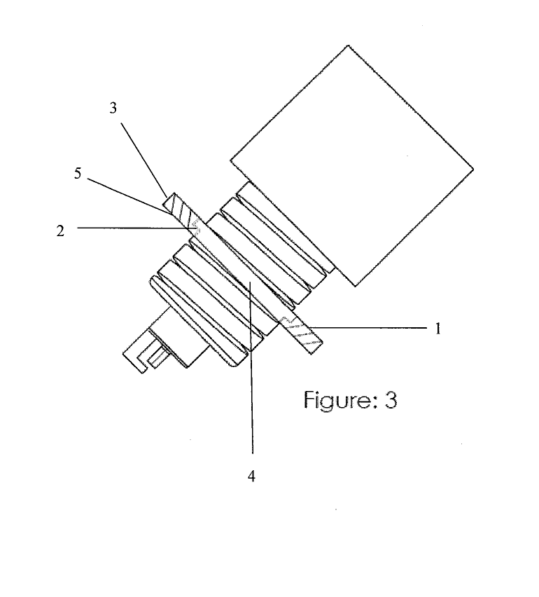

An annular gasket with inner rabbet edge and a corresponding flat edge is illustrated in FIG. 1, FIG. 2, and FIG. 3. The gasket had an outer edge of the annular gasket 3 and a flat bottom edge 5. The top outer edge 1 and inner rabbet edge 2 are further illustrated in the in the descriptive drawings—FIG. 1, FIG. 2, and FIG. 3. The annular gasket with inner rabbet edge constructed of metal, alloy, and/or suitable hard materials.

As illustrated in FIG. 1 the height of the inner rabbet edge 2 is usually about one-half (½) the total height of the annular gasket with inner rabbet edge. The radius of the annular gasket with inner rabbet edge is usually about such that the sum of the radius of the inner rabbet edge 2 plus the radius of the outer edge of the annular gasket 3 and thereafter divided by two (2) is equal to the inner radius of the top outer edge 1. Moreover, the width of the top outer edge 1 and inner rabbet edge 2 are usually about equal—though need not be. The actual size and dimensions of the annular gasket with inner rabbet edge is ultimately dependent on the size of the spark plug and will vary accordingly.

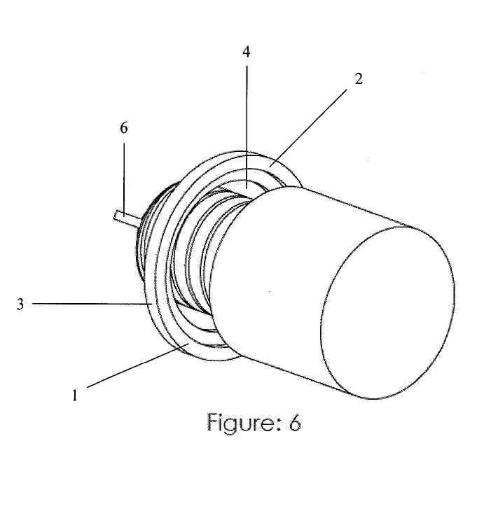

The annular gasket with inner rabbet edge is usually about installed onto the spark plug as illustrated in FIG. 3 and FIG. 6 so that ground electrode 6 of the spark plug is put through the opening 4 and the annular gasket with inner rabbet edge is positioned up along the threads 8 of the spark plug where it comes to rest flatly against he hex-base 7. The annular gasket with inner rabbet edge is usually about installed so that the top outer edge 1 comes to rest flatly against the hex-base 7 of the spark plug and that the flat bottom edge 5 of the annular gasket with inner rabbet edge faces outward toward the ground electrode 6. When the spark plug is installed into the cylinder head, the flat bottom edge 5 comes to rest flatly against the bottom base of the cylinder head.

The annular gasket with inner rabbet edge may also be installed onto the spark plug so that the flat bottom edge 5 comes to rest flatly against the hex-base 7 of the spark plug and that the top outer edge 1 and the inner rabbet edge 2 faces outward toward the ground electrode 6. When installed in this manner, the top outer edge 1 and the inner rabbet edge 2 comes to rest flatly against the bottom base of the cylinder head.

1. An annular gasket comprising flat-squared sides having a flat bottom edge on one side and, on the other opposite side, a flat outer top edge, and a flat rabbet inner edge so as to be installed onto a spark plug such that the flat edge comes to rest against the hex-base of the spark plug and the other opposite side comes to rest against the bottom base of the cylinder head when the spark plug is installed.

2. The annular gasket of claim 1 wherein the height of the inner rabbet edge is approximately one-half of the total height of the annular gasket.

3. The annular gasket of claim 1 wherein the radius of the outer top edge is such that it is approximately equal to the sum of the inner rabbet edge plus the radius of the outer edge of the annular gasket when divided by two.

4. The annular gasket of claim 1 wherein said body of metal and/or alloy.
